(19) United States
(12) Patent Application Publication
(10) Pub. No.: US 2024/0094361 A1
(43) Pub. Date: Mar. 21, 2024

(54) LASER RADAR DEVICE

(71) Applicant: DENSO CORPORATION, Kariya-city (JP)

(72) Inventors: Naoki YOSHIMOTO, Kariya-city (JP); Chihiro MORIGUCHI, Kariya-city (JP)

(21) Appl. No.: 18/520,432

(22) Filed: Nov. 27, 2023

Related U.S. Application Data
(63) Continuation of application No. PCT/JP2022/020654, filed on May 18, 2022.

(30) Foreign Application Priority Data
May 28, 2021 (JP) 2021-090347

(51) Int. Cl. G01S 7/4915; G01S 7/4912; G01S 7/493; G01S 17/34

(52) U.S. Cl. CPC G01S 7/4915; G01S 7/4917; G01S 7/493; G01S 17/34

(57) ABSTRACT

A fine section setting unit of a laser radar device sets, for a beat signal waveform indicating time change of a beat signal amplitude of an up beat signal, a plurality of fine sections within time ranges of the beat signal waveform. A fine section extraction unit extracts at least one fine section satisfying a preset extraction condition indicating that the beat signal amplitude in the fine section is high, from among the set plurality of fine sections. A peak detection unit subjects the beat signal in the extracted fine section to frequency analysis to calculate a fine section frequency spectrum and detect a peak frequency, which is a peak in the fine section frequency spectrum.

### CROSS-REFERENCE TO RELATED APPLICATION

The present application is based on and claims the benefit of priority from earlier Japanese Patent Application No. 2021-090347 filed on May 28, 2021, the description of which is incorporated herein by reference.

### BACKGROUND

### Technical Field

The present disclosure relates to a laser radar device.

### Related Art

A laser radar device employing an FMCW system is disclosed which divides a modulation section including an up modulation section, in which frequency gradually increases as time elapses, and a down modulation section, in which frequency gradually decreases as time elapses, into a plurality of sections shorter than the up modulation section and the down modulation section, and processes and thereafter averages the divided sections. FMCW is an abbreviation for Frequency Modulated Continuous Wave.

### SUMMARY

An aspect of the present disclosure provides a laser radar device, including:
a transmission unit that is configured to transmit laser light that has been subjected to frequency modulation, so that a preset modulation period includes an up modulation section in which frequency increases as time elapses and a down modulation section in which frequency decreases as time elapses;
a reception unit that is configured to receive the laser light that has been transmitted from the transmission unit and reflected by an object and mixes the received laser light and the laser light transmitted from the transmission unit to generate a beat signal;
a fine section setting unit that is configured, for an up beat signal waveform indicating time change of a beat signal amplitude, which is an amplitude of the beat signal, of an up beat signal, which is the beat signal in the up modulation section and a down beat signal waveform indicating time change of the beat signal amplitude of a down beat signal, which is the beat signal in the down modulation section, to set a plurality of fine sections within time ranges of the up beat signal waveform and the down beat signal waveform;
a fine section extraction unit that is configured to, for each of the up beat signal waveform and the down beat signal waveform, extract at least one fine section satisfying a preset extraction condition indicating that the beat signal amplitude in the fine section is high, from among the set plurality of fine sections;
a peak detection unit that is configured to, for each of the up beat signal waveform and the down beat signal waveform, subject the beat signal in the extracted fine section to frequency analysis to calculate a fine section frequency spectrum, which is a frequency spectrum in the fine section, and detect a peak frequency, which is a peak in the fine section frequency spectrum; and
a distance calculation unit that is configured to calculate a distance to the object based on the peak frequency detected by the peak detection unit.

### BRIEF DESCRIPTION OF THE DRAWINGS

In the accompanying drawings:

FIG. 1 is a block diagram illustrating a configuration of a laser radar device;

FIG. 2 is a flowchart illustrating a distance measuring process according to a first embodiment;

FIG. 3 is a diagram describing a method of detecting a peak frequency according to the first embodiment;

FIG. 4 is a flowchart illustrating a distance measuring process according to a second embodiment;

FIG. 5 is a diagram describing a method of detecting a peak frequency according to the second embodiment;

FIG. 6 is a flowchart illustrating a distance measuring process according to a third embodiment;

FIG. 7 is a diagram illustrating up extraction frequency spectra and an up average frequency spectrum in second, third, and fourth fine sections;

FIG. 8 is a diagram illustrating fine sections according to a fourth embodiment;

FIG. 9 is a flowchart illustrating a distance measuring process according to a fifth embodiment; and

FIG. 10 is a diagram illustrating amplitude fluctuation verification sections according to the fifth embodiment.

### DETAILED DESCRIPTION OF THE PREFERRED EMBODIMENTS

US 2020/0241139 A1 disclose a laser radar device employing an FMCW system that divides a modulation section including an up modulation section, in which frequency gradually increases as time elapses, and a down modulation section, in which frequency gradually decreases as time elapses, into a plurality of sections shorter than the up modulation section and the down modulation section, and processes and thereafter averages the divided sections. FMCW is an abbreviation for Frequency Modulated Continuous Wave.

Detailed studies by the inventor found a problem that, in a laser radar device employing an FMCW system, the amplitude of a beat signal varies under the influence of speckle generated by interference of laser light due to roughness of a surface of an object that reflects the laser light, and the signal-noise ratio of a frequency spectrum lowers which is calculated by subjecting the beat signal to frequency analysis. Due to the lowered signal-noise ratio, detection accuracy of the laser radar device decreases.

The present disclosure increases detection accuracy of a laser radar device.

### First Embodiment

Hereinafter, a first embodiment of the present disclosure will be described with reference to the drawings.

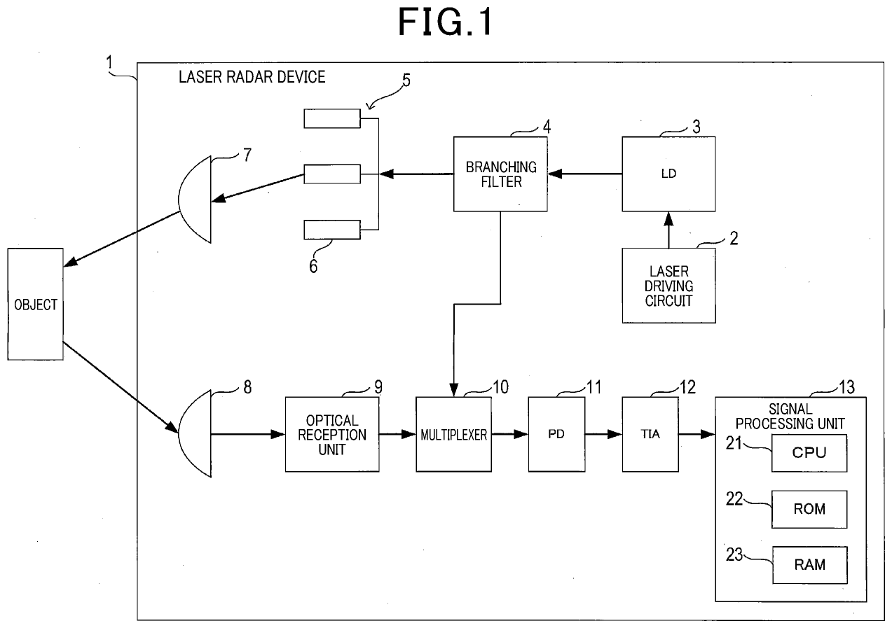

A laser radar device 1 of the present embodiment employs a well-known FMCW system, and, as illustrated in FIG. 1, includes a laser driving circuit 2, a laser diode 3, a branching filter 4, an optical phased array (hereinafter, OPA) 5, phase shifters 6, a diffusing lens 7, a condenser lens 8, an optical reception unit 9, a multiplexer 10, a photodiode 11, a transimpedance amplifier (hereinafter, TIA) 12, and a signal processing unit 13. FMCW is an abbreviation for Frequency Modulated Continuous Wave.

The laser driving circuit 2 outputs a driving signal for generating laser light, whose frequency has been swept, to the laser diode 3.

The laser diode 3 repeatedly emits the laser light whose frequency has been swept (hereinafter, transmission light) based on the driving signal output from the laser driving circuit 2. Specifically, the laser diode 3 generates transmission light, which has been modulated so as to have an up modulation section in which frequency linearly increases with respect to time and a down modulation section in which frequency linearly decreases with respect to time, with a preset modulation period Tm and emits the transmission light.

The branching filter 4 is configured by, for example, a coupler in which an optical waveguide branches and receives the transmission light emitted from the laser diode 3. The branching filter 4 emits part of the transmission light received by the branching filter 4 to the OPA 5 and emits the remaining part to the multiplexer 10.

The transmission light emitted from the branching filter 4 toward the OPA 5 branches into a plurality of optical waveguides and enters the OPA 5. The phase shifters 6 are provided to the respective plurality of optical waveguides and change phases of the transmission light passing through the respective optical waveguides. Hence, directivity of the transmission light emitted from the optical waveguides changes, and the transmission light is used for scanning in the horizontal direction.

It is noted that, instead of the OPA 5 and the phase shifters 6, a mirror and a mirror driving circuit may be included. In this case, the transmission light emitted from the branching filter 4 toward the mirror is reflected by the mirror. Then, the mirror is rotated by the mirror driving circuit, whereby the transmission light reflected by the mirror is used for scanning in the horizontal direction.

The diffusing lens 7 diffuses the emitted transmission light to form a line beam.

The condenser lens 8 collects the reflected light that is the transmission light reflected by an object and emits the reflected light to the optical reception unit 9.

The optical reception unit 9 receives the reflected light emitted from the condenser lens 8 as reception light.

The multiplexer 10 mixes the transmission light received from the branching filter 4 and the reception light received from the optical reception unit 9 to generate a beat signal.

The photodiode 11 converts the beat signal received from the multiplexer 10 to a current signal and outputs the current signal.

The TIA 12 concerts the current signal received from the photodiode 11 to a voltage signal and outputs the voltage signal.

The signal processing unit 13 is an electronic control unit mainly configured by a microcomputer including a CPU 21, a ROM 22, a RAM 23, and the like. Various functions of the microcomputer are implemented by the CPU 21 executing a program stored in a non-transitory tangible storage medium. In this example, the ROM 22 corresponds to the non-transitory tangible storage medium storing the program. Executing the program performs a method corresponding to the program. Some or all of the functions implemented by the CPU 21 may be performed by hardware such as one or more ICs. The number of microcomputers configuring the signal processing unit 13 may be one or more.

The signal processing unit 13 includes an A/D conversion circuit, a fast Fourier transform circuit, and the like. The signal processing unit 13 converts the voltage signals sequentially received from the TIA 12 to digital signals and sequentially stores the values indicated by the digital signals as amplitudes of the beat signal in the RAM 23 to generate beat signal waveform data indicating time change of the amplitude of the beat signal. Then, the signal processing unit 13 subjects the beat signal waveform data to frequency analysis to calculate a distance to an object and a speed of the object. In addition, the signal processing unit 13 calculates an angle of the object based on the scanning direction of the transmission light.

In the FMCW system, as the beat signal, an up beat signal and a down beat signal are generated. The up beat signal is generated by mixing the transmission light and the reception signal during a time period during which radar waves in the up modulation section are transmitted. Similarly, the down beat signal is generated by mixing the transmission light and the reception signal during a time period during which radar waves in the down modulation section are transmitted.

Then, the following expressions (1) and (2) are established between a frequency fbu of the up beat signal and a frequency fbd of the down beat signal, and a distance L to an object (hereinafter, object distance L) and a relative speed v (hereinafter, object relative speed v). It the expressions (1) and (2), c is the speed of light, Δf is a frequency variation range of the transmission light, and f0 is a center frequency of the transmission light.

$$[ Expression 1 ]$$

$$fbu = \frac{4 * Δ f * L}{c * Tm} - \frac{2 * f 0 * v}{c} \qquad ( 1 )$$

$$fbd = \frac{4 * Δ f * L}{c * Tm} + \frac{2 * f 0 * v}{c} \qquad ( 2 )$$

Hence, the object distance L and the object relative speed v are calculated by the following expressions (3) and (4).

$$[ Expression 2 ]$$

$$L = \frac{c * Tm}{8 * Δ f} ( fbu + fbd ) \qquad ( 3 )$$

$$v = \frac{c}{4 * f 0} ( fbu - fbd ) \qquad ( 4 )$$

In the laser radar device 1 configured as described above, the signal processing unit 13 performs the distance measuring process. The distance measuring process is performed every time a modulation period Tm elapses while the signal processing unit 13 is operating.

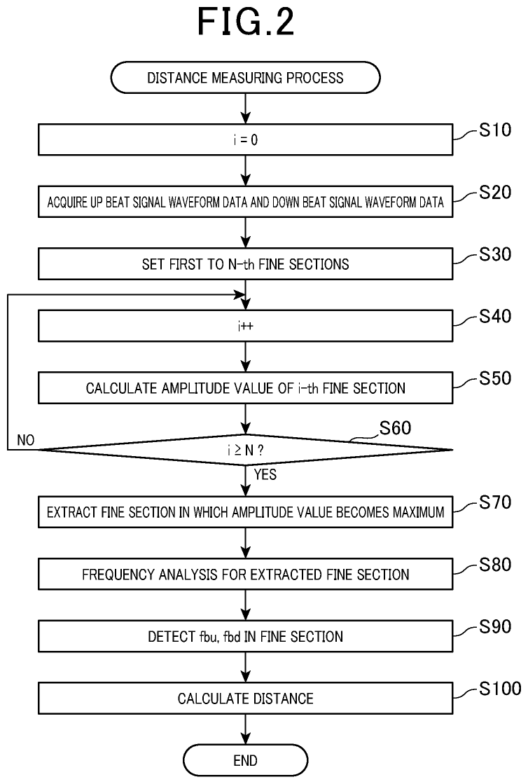

When the distance measuring process is performed, as illustrated in FIG. 2, first in step S10, the CPU 21 of the signal processing unit 13 sets a section indicated value i provided in the RAM 23 to 0.

Then, in step S20, the CPU 21 acquires beat signal waveform data generated in an immediate up modulation section (hereinafter, up beat signal waveform data) and beat signal waveform data generated in an immediate down modulation section (hereinafter, down beat signal waveform data) from the RAM 23.

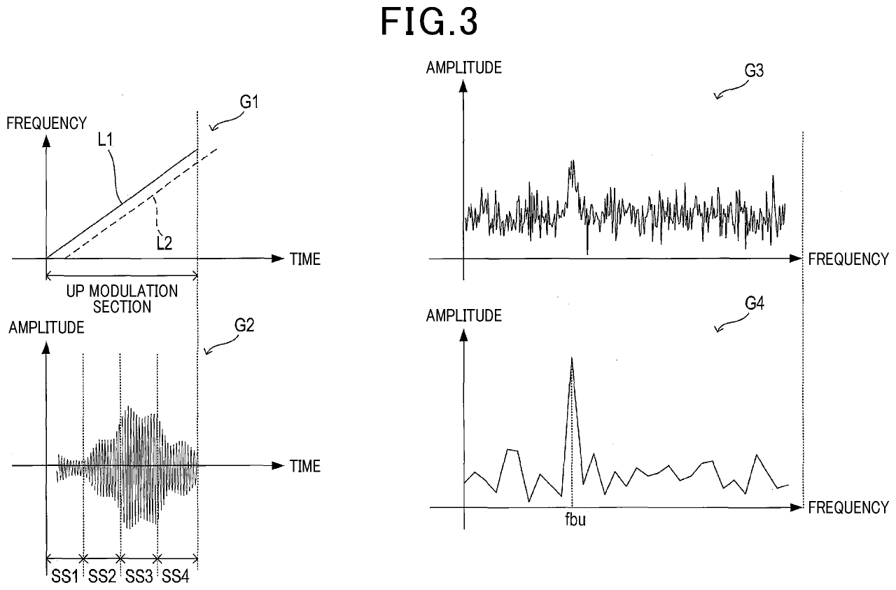

A graph G1 in FIG. 3 indicates time change of frequencies of the transmission light and the reception light in the up modulation section. A straight line L1 indicates time change of the frequency of the transmission light. A straight line L2 indicates time change of the frequency of the reception light.

Next, as illustrated in FIG. 2, in step S30, for the respective up beat signal waveform data and down beat signal waveform data, the CPU 21 first sets fine sections, which are divided into a predetermined division number N of sections and which do not overlap with each other, within time ranges of the up beat signal waveform data and the down beat signal waveform data. The predetermined division number N is an integer equal to or more than 2. Hereinafter, the fine sections, which are divided into a predetermined division number N of sections, are respectively referred to as a first fine section SS1, a second fine section SS2, . . . , and an Nth fine section SSN in order of time.

A graph G2 in FIG. 3 indicates the first fine section SS1, the second fine section SS2, the third fine section SS3, and the fourth fine section SS4 obtained by dividing the beat signal waveform in the up modulation section.

In addition, as illustrated in FIG. 2, in step S40, the CPU 21 increments the section indicated value i (i.e., adds 1).

Then, in step S50, for each of the up beat signal waveform data and the down beat signal waveform data, the CPU 21 calculates an amplitude value of the beat signal in the i-th fine section SSi. In the present embodiment, an effective value is employed as the amplitude value. It is enough for the amplitude value to be an indicator indicating the magnitude of a signal in the fine section. For example, an average value of the absolute values may be employed.

Next, in step S60, the CPU 21 determines whether the section indicated value i is the predetermined division number N or more. If the section indicated value i is less than the predetermined division number N, the CPU 21 proceeds to step S40. In contrast, if the section indicated value i is the predetermined division number N or more, in step S70, the CPU 21 extracts a fine section in which the amplitude value becomes maximum, for each of the up beat signal waveform data and the down beat signal waveform data. Hereinafter, the fine section extracted from the up beat signal waveform data is referred to as an up extraction fine section, and the fine section extracted from the down beat signal waveform data is referred to as a down extraction fine section.

Then, in step S80, the CPU 21 first performs frequency analysis processing for the up beat signal waveform data in the up extraction fine section to calculate a frequency spectrum of the up beat signal (hereinafter, up extraction frequency spectrum). The frequency spectrum indicates frequencies included in the beat signal and amplitudes at the respective frequencies. In the present embodiment, the above frequency analysis processing is fast Fourier transformation.

Furthermore, the CPU 21 performs frequency analysis processing for the down beat signal waveform data in the down extraction fine section to calculate a frequency spectrum of the down beat signal (hereinafter, down extraction frequency spectrum).

A graph G3 in FIG. 3 indicates a frequency spectrum calculated by performing frequency analysis processing for the up beat signal waveform data in the whole section of the up modulation section.

A graph G4 in FIG. 3 indicates a frequency spectrum calculated by performing frequency analysis processing for the up beat signal waveform data in the third fine section SS3 in the up modulation section.

In comparison between the graph G3 and the graph G4, the signal-noise ratio is higher in the graph G4 than in the graph G3. In contrast, time resolution is higher in the graph G3 than in the graph G4.

Next, as illustrated in FIG. 2, in step S90, the CPU 21 detects, as the frequency fbu, a frequency peak present on the up extraction frequency spectrum calculated in step S80, and detects, as the frequency fbd, a frequency peak present on the down extraction frequency spectrum calculated in step S80.

Next, in step S100, the CPU 21 uses the frequency fbu and the frequency fbd detected in step S90 to calculate the object distance L and terminates the distance measuring process.

The laser radar device 1 configured as described above includes the laser driving circuit 2, the laser diode 3, the optical reception unit 9, the multiplexer 10, and the signal processing unit 13.

The laser driving circuit 2 and the laser diode 3 transmit laser light that has been subjected to frequency modulation, so that the preset modulation period Tm includes the up modulation section in which the frequency gradually increases as time elapses and the down modulation section in which the frequency gradually decreases as time elapses.

The optical reception unit 9 and the multiplexer 10 receive the laser light that has been transmitted from the laser diode 3 and reflected by an object and mixes the received laser light and the laser light transmitted from the laser diode 3 to generate a beat signal.

The signal processing unit 13 sets the fine sections, the predetermined division number of which is N, within time ranges of the up beat signal waveform and the down beat signal waveform, for the up beat signal waveform indicating time change of the beat signal amplitude of the up beat signal and the down beat signal waveform indicating time change of the beat signal amplitude of the down beat signal.

The signal processing unit 13 extracts at least one fine section satisfying a preset extraction condition indicating that the beat signal amplitude in the fine section is high, from among the set fine sections, the predetermined division number of which is N, for the up beat signal waveform and the down beat signal waveform. The extraction condition of the present embodiment is that the beat signal amplitude is the maximum.

The signal processing unit 13 subjects the beat signal in the extracted fine section to frequency analysis, for the up beat signal waveform and the down beat signal waveform, to calculate the up extraction frequency spectrum and the down extraction frequency spectrum, and detects the frequency fbu and the frequency fbd that become peaks in the up extraction frequency spectrum and the down extraction frequency spectrum.

The signal processing unit 13 calculates the object distance L based on the detected frequency fbu and frequency fbd.

The laser radar device 1 described above performs frequency analysis for only the fine section of the beat signal waveform in which the beat signal amplitude is high to detect the frequency fbu and the frequency fbd. Hence, the laser radar device 1 can increase the signal-noise ratio of the frequency spectrum calculated by the frequency analysis, whereby detection accuracy of the laser radar device 1 can be increased.

In the embodiment described above, the laser driving circuit 2 and the laser diode 3 correspond to a transmission unit, and the optical reception unit 9 and the multiplexer 10 correspond to reception unit.

In addition, step S30 corresponds to processing as a fine section setting unit, steps S40 to S70 correspond to processing as a fine section extraction unit, steps S80 and S90 correspond to processing as a peak detection unit, and step S100 corresponds to processing as a distance calculation unit.

In addition, the up extraction frequency spectrum and the down extraction frequency spectrum correspond to fine section frequency spectra, and the frequency fbu and the frequency fbd correspond to peak frequencies.

### Second Embodiment

Hereinafter, a second embodiment of the present disclosure will be described with reference to the drawings. In the second embodiment, parts different from the first embodiment will be described. Common components are denoted by the same reference sign.

The laser radar device 1 of the second embodiment differs from that of the first embodiment in that the distance measuring process is modified.

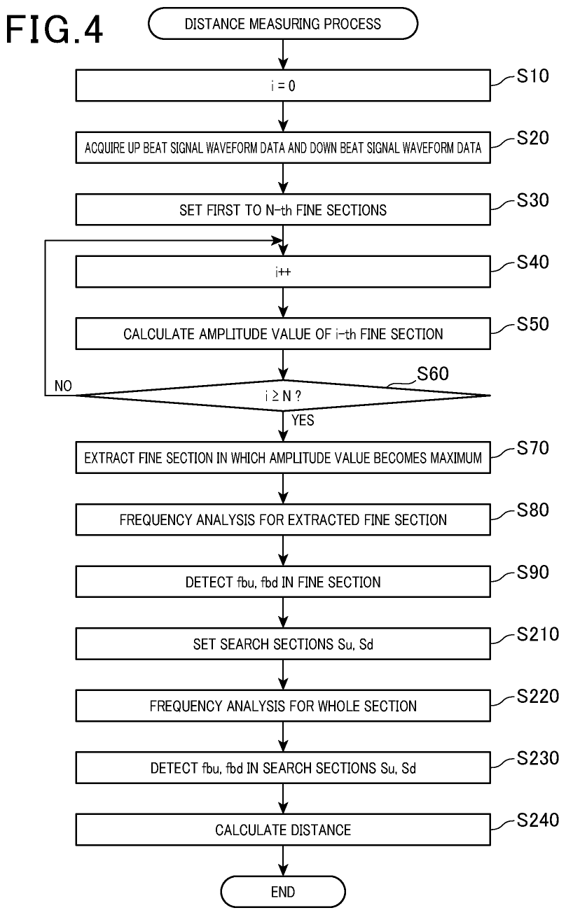

The distance measuring process of the second embodiment differs from that of the first embodiment in that, as illustrated in FIG. 4, the processing of step S100 is omitted, and processing of steps S210 to S240 is added.

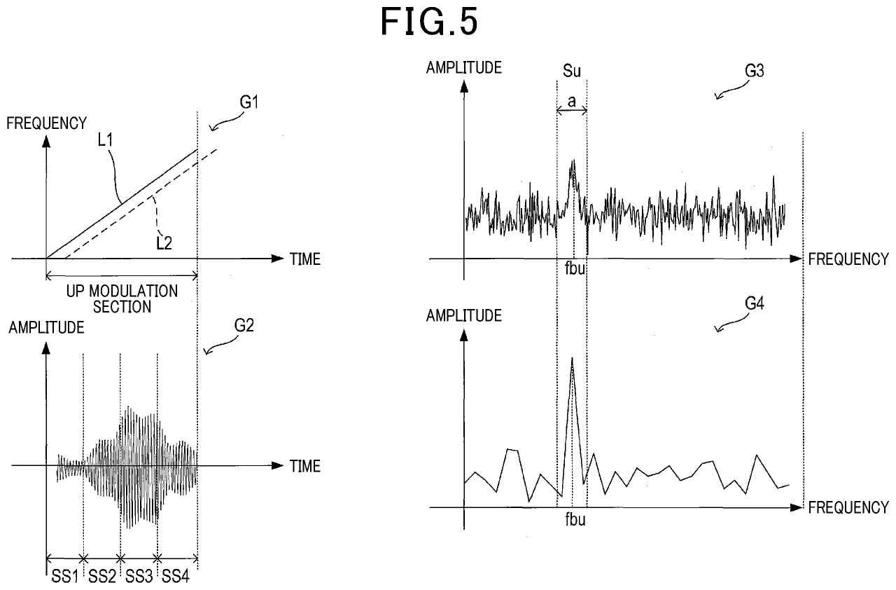

That is, when the processing of step S90 ends, in step S210, the CPU 21 uses the frequency fbu and the frequency fbd detected in step S90 to set an up search section Su and a down search section Sd. As illustrated in FIG. 5, the up search section Su is a frequency range from fbu−(a/2) to fbu+(a/2), where a is a search frequency width. The down search section Sd is a frequency range from fbd−(a/2) to fbd+(a/2). It is noted that the down search section Sd is not illustrated in FIG. 5.

Then, as illustrated in FIG. 4, in step S220, the CPU 21 first performs frequency analysis processing for the up beat signal waveform data in the up modulation section to calculate a frequency spectrum of the up beat signal (hereinafter, up whole section frequency spectrum). Furthermore, the CPU 21 performs frequency analysis processing for the down beat signal waveform data in the down modulation section to calculate a frequency spectrum of the down beat signal (hereinafter, down whole section frequency spectrum).

Next, in step S230, the CPU 21 detects, as the frequency fbu, a frequency peak present in the up search section Su in the up whole section frequency spectrum calculated in step S220. In addition, the CPU 21 detects, as the frequency fbd, a frequency peak present in the down search section Sd in the down whole section frequency spectrum calculated in step S220.

Then, in step S240, the CPU 21 uses the frequency fbu and the frequency fbd detected in step S230 to calculate the object distance L and terminates the distance measuring process.

In the laser radar device 1 configured as described above, for the respective up beat signal and down beat signal, the signal processing unit 13 sets the up search section Su and the down search section Sd including the detected frequency fbu and frequency fbd.

In addition, the signal processing unit 13 subjects the beat signal in the whole section of the time range to frequency analysis, for the up beat signal waveform and the down beat signal waveform, to calculate the up whole section frequency spectrum and the down whole section frequency spectrum.

Then, the signal processing unit 13 detects the frequency fbu and the frequency fbd in the up search section Su and the down search section Sd of the up whole section frequency spectrum and the down whole section frequency spectrum to calculate the object distance L.

The laser radar device 1 described above detects a conclusive frequency fbu and a conclusive frequency fbd using the up whole section frequency spectrum and the down whole section frequency spectrum having frequency resolution higher than that of the up extraction frequency spectrum and the down extraction frequency spectrum. Hence, the laser radar device 1 can increase detection accuracy of the frequency fbu and the frequency fbd, whereby detection accuracy of the laser radar device 1 can be further increased.

In the embodiment described above, step S210 corresponds to processing as a search section setting unit, step S220 corresponds to processing as a spectrum calculation unit, S230 to S240 correspond to processing as a distance calculation unit, and the up whole section frequency spectrum and the down whole section frequency spectrum correspond to a whole section frequency spectrum.

### Third Embodiment

Hereinafter, a third embodiment of the present disclosure will be described with reference to the drawings. In the third embodiment, parts different from the second embodiment will be described. Common components are denoted by the same reference sign.

The laser radar device 1 of the third embodiment differs from that of the second embodiment in that the distance measuring process is modified.

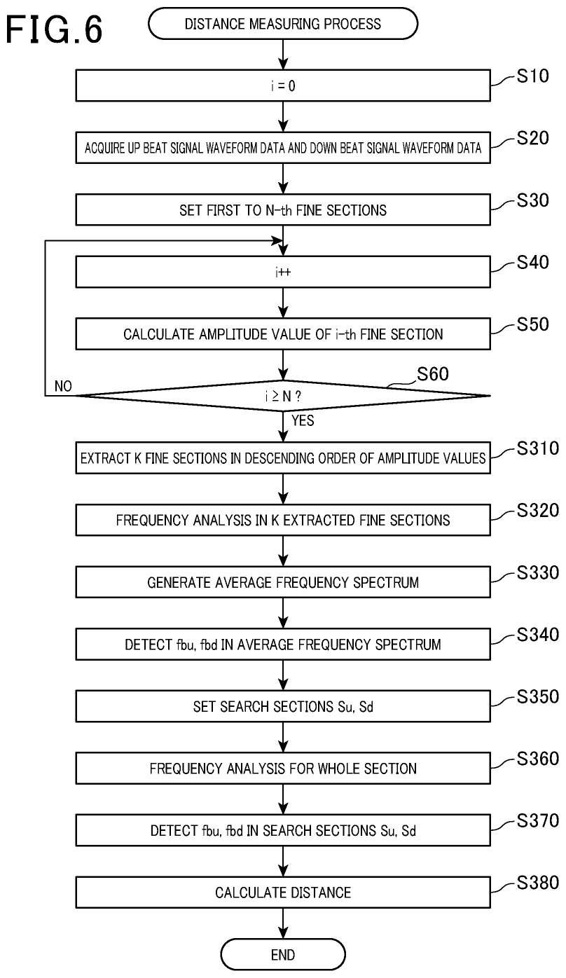

The distance measuring process of the third embodiment differs from that of the second embodiment in that, as illustrated in FIG. 6, the processing of steps S70, S80, S90, S210 to S240 is omitted, and processing of steps S310 to S380 is added.

That is, if the section indicated value i is the predetermined division number N or more in step S60, in step S310, the CPU 21 extracts fine sections, the number of extraction sections of which is K, in descending order of the amplitude value, for the up beat signal waveform data and the down beat signal waveform data. The number of extraction sections K is an integer equal to or more than 2 and less than N.

Then, in step S320, the CPU 21 first performs frequency analysis processing for the up beat signal waveform data in the up extraction fine sections, the number of extraction sections of which is K, to calculate the up extraction frequency specta, the number of extraction sections of which is K.

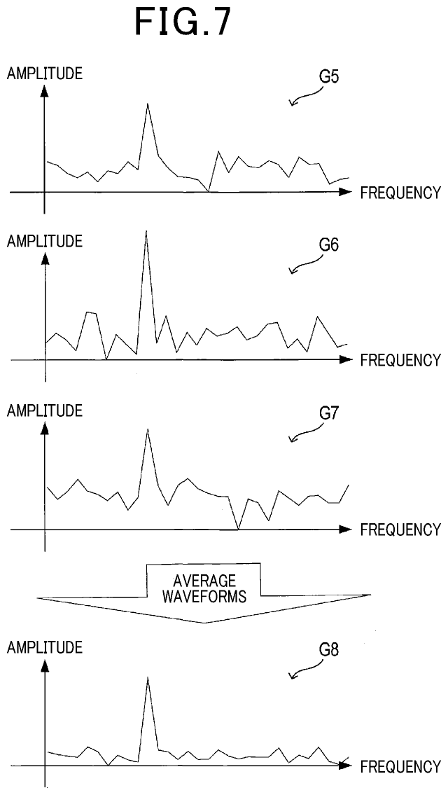

A graph G5 in FIG. 7 indicates the up extraction frequency spectrum calculated by performing frequency analysis processing for the up beat signal waveform data in the second fine section SS2 illustrated in the graph G2 in FIG. 2.

A graph G6 in FIG. 7 indicates the up extraction frequency spectrum calculated by performing frequency analysis processing for the up beat signal waveform data in the third fine section SS3 illustrated in the graph G2 in FIG. 2.

A graph G7 in FIG. 7 indicates the up extraction frequency spectrum calculated by performing frequency analysis processing for the up beat signal waveform data in the fourth fine section SS4 illustrated in the graph G2 in FIG. 2.

Furthermore, as illustrated in FIG. 6, in step S320, the CPU 21 performs frequency analysis processing for the down beat signal waveform data in the down extraction fine section to calculate the down extraction frequency spectrum, the number of extraction sections of which is K.

Next, in step S330, the CPU 21 calculates an up average frequency spectrum by averaging amplitudes of the up extraction frequency spectra, the number of extraction sections of which is K, calculated in step S320 and a down average frequency spectrum by averaging amplitudes of the down extraction frequency spectra, the number of extraction sections of which is K, calculated in step S320.

A graph G8 in FIG. 7 indicates the up average frequency spectrum obtained by averaging amplitudes of the up extraction frequency spectra of the second, third, fourth fine sections SS2, SS3, SS4 illustrated by the graphs G5, G6, G7 in FIG. 7.

Then, as illustrated in FIG. 6, in step S340, the CPU 21 detects, as the frequency fbu, a frequency peak present on the up average frequency spectrum calculated in step S330 and detects, as the frequency fbd, a frequency peak present on the down average frequency spectrum calculated in step S330.

Furthermore, in step S350, as in step S210, the CPU 21 uses the frequency fbu and the frequency fbd detected in step S340 to set the up search section Su and the down search section Sd.

Next, in step S360, as in step S220, the CPU 21 performs frequency analysis processing for the up beat signal waveform data in the up modulation section and the down beat signal waveform data in the down modulation section to respectively calculate the up whole section frequency spectrum and the down whole section frequency spectrum.

Then, in step S370, as in step S230, the CPU 21 detects, as the frequency fbu, a frequency peak present in the up search section Su in the up whole section frequency spectrum calculated in step S360. In addition, the CPU 21 detects, as the frequency fbd, a frequency peak present in the down search section Sd in the down whole section frequency spectrum calculated in step S360.

Then, in step S380, as in step S240, the CPU 21 uses the frequency fbu and the frequency fbd detected in step S370 to calculate the object distance L and terminates the distance measuring process.

In the laser radar device 1 configured as described above, the extraction condition is that fine sections, the number of extraction sections of which is K, which is preset so as to be multiple, are extracted in descending order of the beat signal amplitude. Then, the signal processing unit 13 subjects the beat signals in the extracted fine sections, the number of extraction sections of which is K, to frequency analysis to calculate the up extraction frequency spectrum and the down extraction frequency spectrum in each of the fine sections, the number of extraction sections of which is K. Furthermore, the signal processing unit 13 calculates the up average frequency spectrum and the down average frequency spectrum by averaging amplitudes of the up extraction frequency spectra and the down extraction frequency spectra in the fine sections, the number of extraction sections of which is K, and detects the frequency fbu and the frequency fbd in the calculated up average frequency spectrum and down average frequency spectrum.

The laser radar device 1 described above averages amplitudes of the up extraction frequency spectra and the down extraction frequency spectra in the fine sections, the number of extraction sections of which is K, whereby the up average frequency spectrum and the down average frequency spectrum having increased signal-noise ratios can be obtained. Hence, the laser radar device 1 can increase accuracy in detecting the frequency fbu and the frequency fbd, whereby the detection accuracy of the laser radar device 1 can be further increased.

In the embodiment described above, S310 corresponds to processing as the fine section extraction unit, S320 to S340 correspond to processing as the peak detection unit, and the up average frequency spectrum and the down average frequency spectrum are referred to as an average frequency spectrum.

In addition, S350 corresponds to processing as the search section setting unit, S360 corresponds to processing as the spectrum calculation unit, and S370 to S380 correspond to processing as the distance calculation unit.

### Fourth Embodiment

Hereinafter, a fourth embodiment of the present disclosure will be described with reference to the drawings. In the fourth embodiment, parts different from the first embodiment will be described. Common components are denoted by the same reference sign.

The laser radar device 1 of the fourth embodiment differs from that of the first embodiment in that step S30 in the distance measuring process is modified.

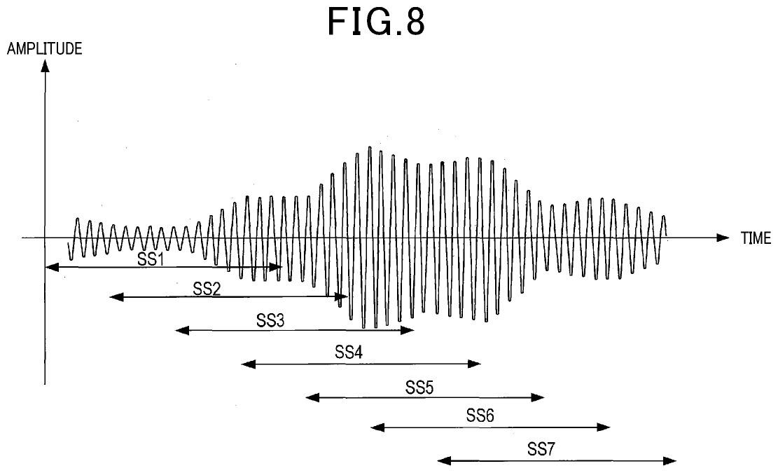

In step S30 in the distance measuring process of the fourth embodiment, as illustrated in FIG. 8, for the respective up beat signal waveform data and down beat signal waveform data, the CPU 21 sets fine sections, the predetermined division number of which is N, so as to overlap with at least an adjacent fine section, within time ranges of the up beat signal waveform data and the down beat signal waveform data. FIG. 8 illustrates setting of fine sections when the predetermined division number N is b 7.

In the laser radar device 1 configured as described above, the signal processing unit 13 sets each of the plurality of fine sections so that part of the fine section overlaps with at least one of the other fine sections. Hence, in the laser radar device 1, a fine section in which the signal-noise ratio is higher can be extracted. Hence, the laser radar device 1 can further increase detection accuracy of the frequency fbu and the frequency fbd, whereby detection accuracy of the laser radar device 1 can be further increased.

### Fifth Embodiment

Hereinafter, a fifth embodiment of the present disclosure will be described with reference to the drawings. In the fifth embodiment, parts different from the first embodiment will be described. Common components are denoted by the same reference sign.

The laser radar device 1 of the fifth embodiment differs from that of the first embodiment in that the distance measuring process is modified.

The distance measuring process of the fifth embodiment differs from that of the first embodiment in that processing of steps S55, S75 is performed instead of that of steps S50, S70.

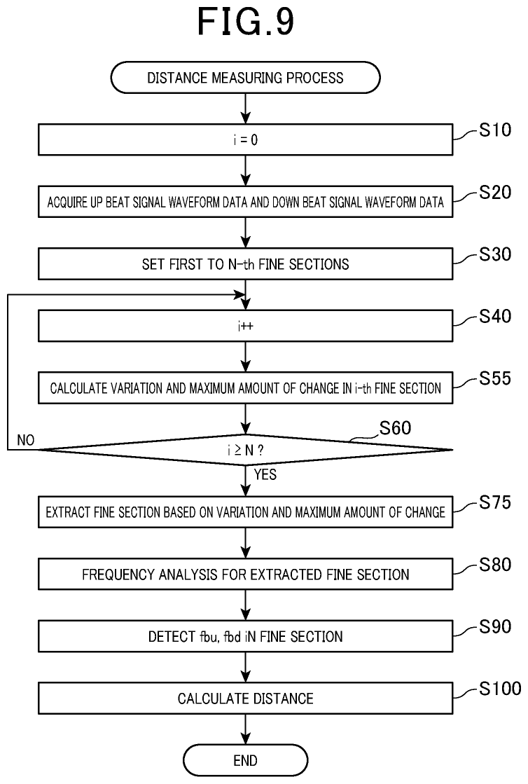

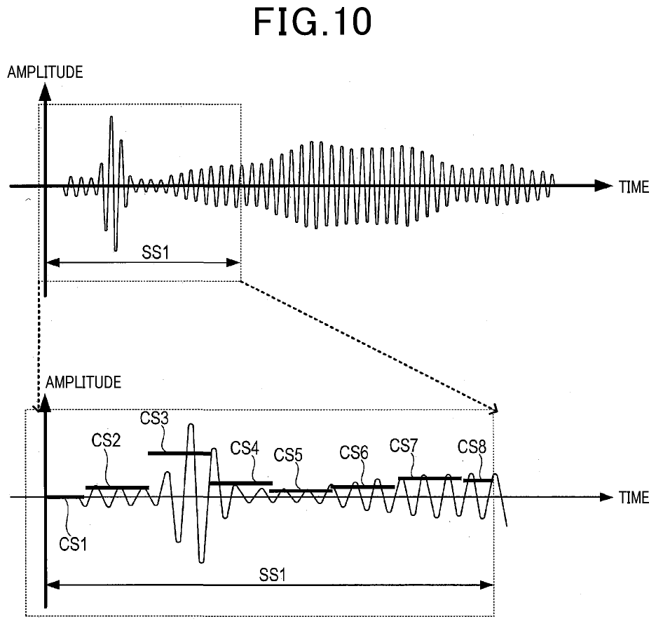

That is, as illustrated in FIG. 9, when the processing of S40 ends, in step S55, the CPU 21 calculates the maximum amount of change and a variation in the i-th fine section SSi. Specifically, the CPU 21 first sets amplitude fluctuation verification sections, the predetermined division number of which is M and which do not overlap with each other, within a time range of the i-th fine section SSi. The amplitude fluctuation verification sections, the predetermined division number of which is M, are respectively referred to as a first amplitude fluctuation verification section CS1, a second amplitude fluctuation verification section CS, . . . , an M-th amplitude fluctuation verification section CSM in order of time. FIG. 10 indicates the first amplitude fluctuation verification section CS1, the second amplitude fluctuation verification section CS, . . . , the eighth amplitude fluctuation verification section CS8, which are set in the first fine section SS1.

Then, the CPU 21 calculates an amplitude fluctuation value in each of the first amplitude fluctuation verification section CS1, the second amplitude fluctuation verification section CS2, . . . , the M-th amplitude fluctuation verification section CSM. The amplitude fluctuation value is an average value of absolute values of amplitude values at peak times in each of the amplitude fluctuation verification section. In FIG. 10, the heights of horizontal bars indicating the first to eighth amplitude fluctuation verification sections CS1 to CS8 indicate the amplitude values.

Furthermore, the CPU 21 sets, as the maximum amount of change in the i-th fine section SSi, the maximum amplitude fluctuation value among the amplitude fluctuation values in the first amplitude fluctuation verification section CS1, the second amplitude fluctuation verification section CS2, . . . , the M-th amplitude fluctuation verification section CSM. In addition, the CPU 21 sets, as the variation in the i-th fine section SSi, a standard deviation of the amplitude fluctuation values in the first amplitude fluctuation verification section CS1, the second amplitude fluctuation verification section CS2, . . . , the M-th amplitude fluctuation verification section CSM.

As illustrated in FIG. 9, in step S60, if the section indicated value i is the predetermined division number N or more, in step S75, for each of the up beat signal waveform data and the down beat signal waveform data, the CPU 21 extracts a fine section in which the maximum amount of change is the maximum from among fine sections in which the value of the variation is less than a preset extraction threshold value.

Then, when the processing of step S75 ends, the CPU 21 proceeds to step S80.

In the laser radar device 1 configured as described above, the signal processing unit 13 divides each of the plurality of fine sections into a plurality of amplitude fluctuation verification sections and verifies the beat signal amplitude for each of the plurality of amplitude fluctuation verification sections to extract the fine section satisfying the extraction condition.

The laser radar device 1 described above can prevent occurrence of an situation in which, due to generation of noise whose beat signal amplitude instantaneously increases in a fine section, the fine section is extracted, whereby the fine section in which the beat signal amplitude is high overall can be extracted. Hence, the laser radar device 1 can prevent occurrence of a situation in which a fine section in which the signal-noise ratio is low is extracted. Thus, the laser radar device 1 can further increase detection accuracy of the frequency fbu and the frequency fbd, whereby detection accuracy of the laser radar device 1 can be further increased.

In the embodiment described above, S40, S55, S60, S75 correspond to processing as the fine section extraction unit.

Embodiments of the present disclosure have been described above. However, the present disclosure is not limited to the above embodiments and can be variously modified.

The signal processing unit 13 and the processing thereof described in the present disclosure may be implemented by a dedicated computer which is provided by configuring a processor and a memory that are programmed to execute one or more functions embodied by a computer program. Alternatively, the signal processing unit 13 and the processing thereof described in the present disclosure may be implemented by a dedicated computer which is provided by configuring a processor with one or more dedicated hardware logic circuits. Alternatively, the signal processing unit 13 and the processing thereof described in the present disclosure may be implemented by one or more dedicated computers which are configured by combining a processor and a memory that are programmed to execute one or more functions, with a processor that is configured by one or more hardware logic circuits. Furthermore, the computer program may be stored in a computer readable non-transitory tangible recording medium, as instructions to be executed by the computer. The method implementing functions of parts included in the signal processing unit 13 may not necessarily include software. All the functions may be implemented by one or a plurality of hardware components.

A plurality of functions of a single component of the above embodiments may be implemented by a plurality of components. One function of one component may be implemented by a plurality of components. A plurality of functions of a plurality of components may be implemented by a single component. One function implemented by a plurality of components may be implemented by a single component. Furthermore, part of the configuration of the above embodiments may be omitted. Furthermore, at least part of the configuration of the above embodiments may be added to or replaced by another part of the configuration of the embodiments.

The present disclosure may be implemented by, in addition to the laser radar device 1 described above, various forms such as a system including the laser radar device 1 as a component, a program for causing a computer to function as the laser radar device 1, a non-transitory tangible recording medium such as a semiconductor memory storing the program, and a distance measuring method.

An aspect of the present disclosure provides a laser radar device (1), including:
a transmission unit (2, 3) that is configured to transmit laser light that has been subjected to frequency modulation, so that a preset modulation period includes an up modulation section in which frequency increases as time elapses and a down modulation section in which frequency decreases as time elapses;
a reception unit (9, 10) that is configured to receive the laser light that has been transmitted from the transmission unit and reflected by an object and mixes the received laser light and the laser light transmitted from the transmission unit to generate a beat signal;
a fine section setting unit (S30) that is configured, for an up beat signal waveform indicating time change of a beat signal amplitude, which is an amplitude of the beat signal, of an up beat signal, which is the beat signal in the up modulation section and a down beat signal waveform indicating time change of the beat signal amplitude of a down beat signal, which is the beat signal in the down modulation section, to set a plurality of fine sections within time ranges of the up beat signal waveform and the down beat signal waveform;
a fine section extraction unit (S40 to S70, S75, S310) that is configured to, for each of the up beat signal waveform and the down beat signal waveform, extract at least one fine section satisfying a preset extraction condition indicating that the beat signal amplitude in the fine section is high, from among the set plurality of fine sections;
a peak detection unit (S80, S90, S320 to S340) that is configured to, for each of the up beat signal waveform and the down beat signal waveform, subject the beat signal in the extracted fine section to frequency analysis to calculate a fine section frequency spectrum, which is a frequency spectrum in the fine section, and detect a peak frequency, which is a peak in the fine section frequency spectrum; and
a distance calculation unit (S100, S230 to S240, S370 to S380) that is configured to calculate a distance to the object based on the peak frequency detected by the peak detection unit.

The laser radar device of the present disclosure described above performs frequency analysis for only the fine section of the beat signal waveform in which the beat signal amplitude is high to detect peak frequencies. Hence, the laser radar device of the present disclosure can increase the signal-noise ratio of the frequency spectrum calculated by the frequency analysis, whereby detection accuracy of the laser radar device can be increased.

What is claimed is:

1. A laser radar device, comprising:
a transmission unit that is configured to transmit laser light that has been subjected to frequency modulation, so that a preset modulation period includes an up modulation section in which frequency increases as time elapses and a down modulation section in which frequency decreases as time elapses;
a reception unit that is configured to receive the laser light that has been transmitted from the transmission unit and reflected by an object and mixes the received laser light and the laser light transmitted from the transmission unit to generate a beat signal;
a fine section setting unit that is configured, for an up beat signal waveform indicating time change of a beat signal amplitude, which is an amplitude of the beat signal, of an up beat signal, which is the beat signal in the up modulation section and a down beat signal waveform indicating time change of the beat signal amplitude of a down beat signal, which is the beat signal in the down modulation section, to set a plurality of fine sections within time ranges of the up beat signal waveform and the down beat signal waveform;
a fine section extraction unit that is configured to, for each of the up beat signal waveform and the down beat signal waveform, extract at least one fine section satisfying a preset extraction condition indicating that the beat signal amplitude in the fine section is high, from among the set plurality of fine sections;
a peak detection unit that is configured to, for each of the up beat signal waveform and the down beat signal waveform, subject the beat signal in the extracted fine section to frequency analysis to calculate a fine section frequency spectrum, which is a frequency spectrum in the fine section, and detect a peak frequency, which is a peak in the fine section frequency spectrum; and
a distance calculation unit that is configured to calculate a distance to the object based on the peak frequency detected by the peak detection unit.

2. The laser radar device according to claim 1, wherein
the extraction condition is that the beat signal amplitude is the maximum, and
the fine section extraction unit extracts one fine section satisfying the extraction condition, for each of the up beat signal waveform and the down beat signal waveform.

3. The laser radar device according to claim 1, wherein
the extraction condition is that the amplitude is the maximum,
the fine section extraction unit extracts one fine section satisfying the extraction condition, for each of the up beat signal waveform and the down beat signal waveform,
the laser radar device further comprises:
a search section setting unit that is configured to, for each of the up beat signal and the down beat signal, set a search section that is a frequency range including the peak frequency detected by the peak detection unit; and
a spectrum calculation unit that is configured to, for each of the up beat signal waveform and the down beat signal waveform, subject the beat signal in a whole section of the time range to frequency analysis, to calculate a whole section frequency spectrum that is the frequency spectrum in the whole section, and
the distance calculation unit detects, for each of the up beat signal and the down beat signal, the peak frequency in the search section in the whole section frequency spectrum, to calculate a distance to the object.

4. The laser radar device according to claim 1, wherein
the extraction condition is that the fine sections, the number of extraction sections of which is preset so as to be multiple, are extracted in descending order of the beat signal amplitude, and
the peak detection unit subjects, for each of the up beat signal waveform and the down beat signal waveform, the beat signals in the extracted fine sections to frequency analysis to calculate the fine section frequency spectrum of each of the extracted fine sections, and calculates an average frequency spectrum by averaging amplitudes of the fine section frequency spectra to detect the peak frequency in the calculated average frequency spectrum.

5. The laser radar device according to claim 1, wherein
the fine section setting unit sets each of the plurality of fine sections so that part of the fine section overlaps with at least one of the other fine sections.

6. The laser radar device according to claim 1, wherein for each of the plurality of fine sections, the fine section extraction unit divides the fine section into a plurality of amplitude fluctuation verification sections and verifies the beat signal amplitude for each of the plurality of amplitude fluctuation verification sections to extract the fine section satisfying the extraction condition.
